(19) United States
(12) Patent Application Publication
(10) Pub. No.: US 2026/0208372 A1
(43) Pub. Date: Jul. 23, 2026

(54) Article Identification And Sorting System And Apparatus And Method of Use Thereof

(71) Applicant: Matoha Instrumentation Ltd, London (GB)

(72) Inventors: Martin Holicky, London (GB); Hans Hon Sang Chan, London (GB); Logan Chase Grant, London (GB)

(21) Appl. No.: 19/135,992

(22) PCT Filed: Dec. 12, 2023
(86) PCT No.: PCT/GB2023/053193

§ 371 Date: Jun. 5, 2025

(30) Foreign Application Priority Data
Dec. 12, 2022 (GB) 2218618.3
Jun. 1, 2023 (GB) 2308195.3

(51) Int. Cl. B25J 15/06; B25J 13/02; B25J 19/02

(52) U.S. Cl. CPC B25J 15/0616; B25J 13/02; B25J 19/021; B25J 19/027

(57) ABSTRACT

An inductive displacement sensor having a magnetically permeable measuring head arranged displaceably and/or rotatably on an elongated support, having at least one measuring loop with a geometric shape changing in response to longitudinal/rotational displacement of the measuring head along the support, and having at least one exciter loop by means of which a magnetic flux can be generated in the measuring head. At least two measuring loops being provided, the first measuring loop formed geometrically in such a way that a response, changing as linearly as possible, to a magnetic excitation of the measuring head emerges with a longitudinal/rotational displacement of the measuring head along the support and the least second measuring loop formed geometrically in such a way that a periodically changing response to a magnetic excitation of the measuring head emerges with a longitudinal/rotational displacement of the measuring head.

The invention to which this application relates is an article identification and/or sorting system and apparatus and a method of use thereof.

A huge amount of fabric waste is created each year around the World. Millions of tons of textile waste are produced in Europe alone each year, and the vast majority of textiles around the World are simply incinerated or sent to landfill. This problem has only been exacerbated by the prevalence of “fast-fashion” retail. A number of companies have seen the opportunity which lies in sorting, recycling and/or reselling of used textile and fabrics. However, tightening regulations and legislation around fabric waste means that fabrics need to be accurately sorted by material, prior to subsequent processing.

A crude approach to such sorting of textile and fabric materials involves employing numerous personnel to manually inspect and sort piles of articles by their material make-up. However, for this process to be quick and effective, a large workforce is required which incurs a huge wage bill, making the whole process cost prohibitive.

Automated and semi-automated approaches have also been used and are known in the art. One technique employed by the Applicant for the present invention involves the provision of a handheld device wherein a user places a fabric article over an infrared sensor incorporated into the device. The infrared spectrum of the article is analysed, and machine learning algorithms incorporated into the circuitry of the device then determines, based on the spectroscopic analysis of the article, what the composition of the material is. This is subsequently indicated on a display of the device to the user, who can then place the article in an appropriate sorting bin. While the process may be quick (from placing the article on the sensor to displaying the material composition takes about 1 second), the process is still labour-intensive and in the grander scheme of things, relatively slow.

Another approach is to provide a wholly automated system, which involves an industrial-sized machine having a single conveyor belt on which articles are placed and move along. As the articles move along the conveyor, a combination of NIR (near-infrared) and RGB cameras are provided to analyse and determine, as the articles are moving, the colour and material composition of those articles. Blowers or mechanical arms then subsequently deposit the articles from the conveyor into the appropriate storage bin. Given that the articles are moving on the conveyor, more advanced and expensive NIR cameras are required compared to those needed when analysing stationary articles. Such industrial setups allow for a large number of articles to be analysed and sorted with a greatly reduced workforce. However, the machines do still require a large amount of space, are very costly, and still do not provide much better performance than the semi-automated approach described above (still only approximately one article per second).

There is therefore a clear need for a more cost- and space-efficient system and apparatus which can identify the composition of an article and sort it appropriately.

It is therefore an aim of the present invention to provide an article identification and/or sorting system and apparatus that overcomes the aforementioned problems associated with the prior art.

It is a further aim of the present invention to provide a method of using an article identification and/or sorting system that overcomes the aforementioned problems associated with the prior art.

According to a first aspect of the invention there is provided an article identification and/or sorting apparatus, said apparatus including:
at least one automated arm member;
said arm member having a first, proximal end and a second, opposing distal end;
the distal end comprising an article gripping portion; and
said gripping portion including at least one gripping member;
characterized in that said at least one gripping member includes spectrometric identification means, or sensing means thereof, provided associated therewith.

Typically, said at least one gripping member includes at least one light source provided therewith. Said light source may be provided so as to illuminate the portion of the article to be identified by the spectrometric identification means. Typically, said at least one light source is located adjacent sensing means of the spectrometric identification means.

Preferably, said spectrometric identification means are provided in the form of an infrared (IR) spectrometer. In some embodiments, said spectrometric identification means are provided as a near-infrared (NIR) spectrometer.

Preferably, said at least one light source is provided as an IR light source. Typically, said light source may be provided as any one of the following: incandescent lamp; halogen lamp; LED; superluminescent diode; or a blackbody source.

In one embodiment, said at least one gripping member is provided as a vacuum gripping member. Typically, the vacuum gripping member includes a vacuum gripping surface.

In one embodiment, at least one aperture is provided, formed in a gripping surface of the gripping member, permitting a vacuum to be applied therethrough, enabling the gripping surface to apply vacuum suction and grip to an article, in use.

In one embodiment, the gripping member comprises at least one channel extending therethrough and to said aperture. Typically, vacuum supply means are provided and which connect with said channel, applying a vacuum therethrough, in use.

In one embodiment, sensing means of said spectrometric identification means include one or more fibre-optic wires, or a fibre-optic wire bundle, connected at proximal ends to at least one light source and the spectrometric identification means. Typically, distal ends of the one or more fibre-optic wires, or fibre-optic wire bundle, are provided associated with the at least one gripping member.

In one embodiment, the spectrometric identification means or sensing means thereof, are provided located with or forming part of a gripping surface of the gripping member.

In one embodiment, said gripping member includes an aperture in a gripping surface thereof, through which the spectrometric identification means or sensing means thereof, are located, and directed outwardly from the gripping surface towards, in use, an article to be gripped and identified.

Typically, sensing means of said spectrometric identification means include one or more fibre-optic wires, or a fibre-optic wire bundle, and which are arranged to extend through a channel in said gripping member to an aperture formed in the gripping surface.

In another embodiment, the spectrometric identification means or sensing means thereof, are located adjacent and/or attached to said at least one gripping member. Typically, the spectrometric identification means, or sensing means thereof, are located adjacent a gripping surface of the gripping member.

Typically, attachment means are provided, attaching the spectrometric identification means, or sensing means thereof to the gripping member.

Typically, a sensing end or surface of the spectrometric identification means or sensing means thereof, is provided to be substantially parallel with a gripping surface of said gripping member. Preferably, said gripping surface is a vacuum gripping surface.

Preferably, said vacuum gripping member is provided to analyse plastics articles, in use.

In another embodiment, said gripping portion includes at least two gripping members. Typically, at least one of said gripping members includes spectrometric identification means, or sensing means thereof, provided associated with a gripping surface thereof.

Typically, said at least two gripping members are arranged to form a finger- or vice-like grip on an article to be analysed, in use. Further typically, gripping surfaces of said gripping members are arranged to grip an article to be analysed, in use. Typically, said article is a fabric article.

In some embodiments, said spectrometric identification means, or sensing means thereof, are provided integrally with or incorporated into said gripping member, and provided associated with a gripping surface thereof.

In other embodiments, sensing means of said spectrometric identification means are provided incorporated into said gripping member, and connected to said spectrometric identification means. Typically, said sensing means are provided as fibre-optic connection means.

In one embodiment, said gripping member includes an aperture through which sensing means of the spectrometric identification means are located, and directed outwardly from the gripping surface towards, in use, an article to be gripped.

Typically, said gripping member includes at least one light source provided therewith. Said light source may be provided so as to illuminate the portion of the article to be identified by the spectrometric identification means. Typically, said at least one light source is located adjacent sensing means of the spectrometric identification means.

Typically, said gripping surface of the gripping member is an article-facing surface thereof.

Typically, said gripping surface of the gripping member includes a cavity or recess formed therein. Preferably, sensing means of the spectrometric identification means and at least one light source are located within said cavity or recess and directed out and away from the gripping surface.

In one embodiment, transparent cover means are provided to cove the cavity or recess. Typically, said cover means create a substantially continuous surface of the gripping surface. Typically, said cover means is formed from glass or sapphire.

In one embodiment, at least a portion of the gripping surface of each of said gripping members is provided to be textured and/or roughened. Typically, said texturing and/or roughening serves to improve the gripping capabilities of the gripping portion when gripping an article, in use.

In one embodiment, computing means are provided associated with the apparatus and in communication with the spectrometric identification means and at least one arm member. Typically, said computing means include processing means provided to resolve and analyse spectra obtained by the spectrometric identification means, in use.

Preferably, said computing means include machine learning algorithms provided to identify, based on the obtained spectral data, the composition of an article gripped by the gripping portion, in use.

Typically, said at least one automated arm member is arranged to be movable, as determined by computing means and based on composition identification of an article gripped by the gripping portion, to deposit said article in a predetermined location, in use.

In one embodiment, said at least one gripping member may further include optical identification means provided therewith. Typically, the provision of optical identification means enables the apparatus to detect and sort articles, in use, by their colour.

In some embodiments, a gripping surface of the at least one gripping member may be formed integrally therewith.

In other embodiments, said gripping surface may be formed as a separate gripping plate, and attachable to the at least one gripping member. Typically, connection means are provided to attach the gripping plate to the at least one gripping member.

In one embodiment, said at least one automated arm member may include further sensing means provided to determine an optimal pick up point of an article, in use. Typically, said further sensing means incorporates machine vision and artificial intelligence (AI) to determine the optimal pick-up point, in use.

Preferably, said at least one automated arm member is provided to be anchored in position at the first, proximal end.

In some embodiments, the at least one automated arm member, or the gripping portion thereof, may further include stereoscopic and/or hyperspectral camera means. Typically, stereoscopic and/or hyperspectral camera means are provided to further aid in the identification of an article, in use.

In some embodiments, the at least one automated arm member, or the gripping portion thereof, may further include metal detection means. Typically, said metal detection means may be provided to detect metal disruptors located within the fabric of an article to be sorted, in use.

In some embodiments, the at least one automated arm member, or the gripping portion thereof, may further include RFID/NFC tag reading means. Typically, said RFID/NFC tag reading means are provided to detect articles comprising such tags, and read the same.

In some embodiments, the at least one automated arm member, or the gripping portion thereof, may further include weight measuring means. Typically, said weight measuring means are provided in the form of a load cell. Typically, said weight measuring means are provided to determine the weight of an article to be sorted.

In some embodiments, the apparatus may include more than one automated arm member.

In one embodiment, wireless communication means may be provided with the apparatus. Typically, said wireless communication means enable the apparatus to be activated and controlled remotely by a user via software on a computer or via a downloadable mobile application.

According to another aspect of the invention there is provided an article identification and/or sorting apparatus, said apparatus including:
at least one automated arm member;
said arm member having a first, proximal end and a second, opposing distal end;
the distal end comprising an article gripping portion; and
said gripping portion including at least two gripping members;
characterized in that at least one of said gripping members includes spectrometric identification means, or sensing means thereof, provided associated with a gripping surface thereof.

The present invention therefore provides an article identification and/or sorting apparatus which is greatly improved over what is currently available in the prior art. The apparatus, in a single action, is arranged to detect and grip an article to be identified, determine the material composition of the same and while doing so, move to deposit it in a predetermined location. This can be done with minimal human interaction, significantly reducing labour costs, and requires far less space than automated examples in the prior art. Thus, in the same such space, multiple apparatus of the present invention may be provided. The apparatus is therefore more cost, time and space efficient compared to the prior art examples.

According to another aspect of the present invention, there is provided an article identification and/or sorting system, said system including:
an article identification and/or sorting apparatus as defined above;
at least one source container; and
at least two destination containers;
characterized in that at least one gripping member of said apparatus includes spectrometric identification means, or sensing means thereof, provided associated therewith, and the gripping portion of the apparatus is arranged, in use, to grip and remove an article from the at least one source container, identify the material composition of the article, and deposit the same in one of the destination containers according to its identified composition, in use.

Typically, said at least one source container and said at least two destination containers are provided to be located about the at least one automated arm member of the apparatus.

Typically, said at least one source container is arranged to contain one or more articles to be identified and sorted, in use.

Typically, said at least two destination containers are arranged to receive one or more articles which have been identified, in use.

Typically, each of said destination containers is arranged to receive one or more articles of a predetermined material or fabric composition.

In one embodiment, the system includes at least one camera means provided associated with each of the source and destination containers. Preferably, said camera means are located so as to be directed towards and view into the containers. Further preferably, said camera means are provided with stereo vision capabilities, enabling them to determine depth and, thus, how full/empty each of said containers is.

Typically, said camera means are provided in communication with computing means of the apparatus, thereby, in use, enabling the apparatus and at least one automated arm member to pause in use if and when the at least one source container becomes empty and/or one of the at least two destination containers become full or exceeds a predetermined level.

In one embodiment, the system includes a framework within which the apparatus is located, and about the framework the source and destination containers are located.

Typically, said at least one automated arm member is located substantially centrally of the framework.

Typically, said camera means may be mounted on a framework associated with the system.

According to another aspect of the present invention, there is provided an article identification and/or sorting system, said system including:
an article identification and/or sorting apparatus as defined above;
at least one source container; and
at least two destination containers;
characterized in that at least one gripping member of said apparatus includes spectrometric identification means provided associated with a gripping surface thereof, and the gripping portion of the apparatus is arranged, in use, to grip and remove an article from the at least one source container, identify the material composition of the article, and deposit the same in one of the destination containers according to its identified composition, in use.

Thus, in a preferred embodiment, in use, the system is arranged to extend the at least one automated arm member into the at least one source container, detect and grip an article to be identified, identify the material composition of the article via the spectrometric identification means and, based on the identified material composition, deposit the article in one of the at least two destination containers.

The system of the present invention therefore provides an efficient means by which numerous articles may be identified and sorted, and which is far improved over the prior art. The system, in a single action, is arranged to detect and grip an article to be identified, from the at least one source container, determine the material composition of the same and while doing so, move to deposit it in the appropriate destination container. For example, a first destination container may require articles composed of 100% cotton; and the second destination requires all other materials. Further destination containers may be included to the system thereby permitting a more precise separation of the articles by material composition, for example, 100% cotton, 100% polyester, polycotton blends, wool products, all other materials etc. This can be done with minimal human interaction—personnel may only be required to empty/replace destination containers and refill/replace the source container(s). However, it is not unrealistic to envisage even this process to be automated. The provision of stereo vision camera means associated with each container, which are in direct communication with the computing means of the system, means that the system can detect when a container is empty or exceeds a predetermined load and can pause the same until that container has been emptied/refilled/replaced before restarting. The features of the system significantly reducing labour costs, and it requires far less space than automated examples in the prior art. Thus, in the same such space, multiple systems of the present invention may be provided. The system of the present invention is therefore more cost, time and space efficient compared to the prior art examples.

According to another aspect of the present invention, there is provided a method of using an article identification and/or sorting system as described above, said method including the steps of:
providing the at least one source container with one or more articles therein to be identified and sorted;
providing at least two destination containers in to which identified articles are to be deposited according to their identified material composition;
activating the at least one automated arm member of the apparatus to extend into and grip a first article with the gripping portion of thereof;
the apparatus analysing and determining the material composition of the article while it is being gripped, via spectrometric identification means or sensing means thereof, associated with a gripping surface of the at least one gripping member of the gripping portion;
the at least one automated arm member moving the article, and based on the identified material composition, depositing the article in one of the at least two destination containers.

In one embodiment, said articles to be identified are articles formed from varying plastics materials, and the at least one gripping member is provided as a vacuum gripping member. Typically, the gripping surface of the vacuum gripping member is provided as a vacuum gripping surface, arranged to apply a vacuum or suction grip to the article to be analysed.

In another embodiment, said articles to be identified are articles formed from varying fabric materials, and the gripping portion includes at least two gripping members, the gripping surfaces of which are arranged to form a finger-or vice-like grip on an article to be analysed.

According to another aspect of the present invention, there is provided a method of using an article identification and/or sorting system as described above, said method including the steps of:
providing the at least one source container with one or more articles therein to be identified and sorted;
providing at least two destination containers in to which identified articles are to be deposited according to their identified material composition;
activating the at least one automated arm member of the apparatus to extend into and grip a first article with the gripping portion of thereof;
the apparatus analysing and determining the material composition of the article while it is being gripped, via spectrometric identification means associated with a gripping surface of at least one gripping member of the gripping portion;
the at least one automated arm member moving the article, and based on the identified material composition, depositing the article in one of the at least two destination containers.

Typically, each of said destination containers is arranged to receive one or more articles of a predetermined material or fabric composition.

Embodiments of the present invention will now be described with reference to the accompanying figures, wherein:

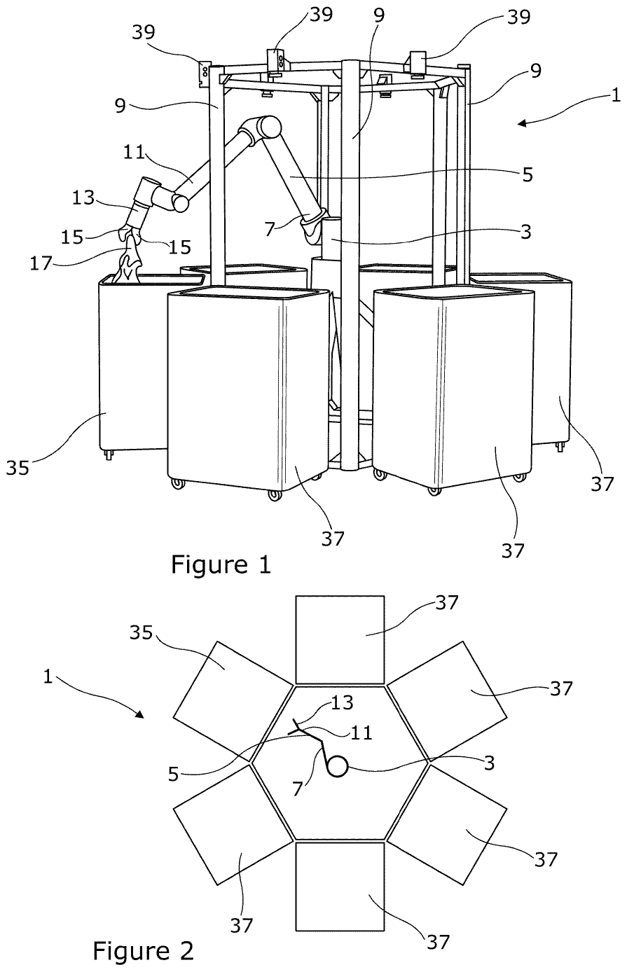

FIG. 1 illustrates a view of an article identification and/or sorting system in accordance with an embodiment of the present invention;

FIG. 2 illustrates plan view of a schematic showing a possible layout of an article identification and/or sorting system, in accordance with an embodiment of the present invention;

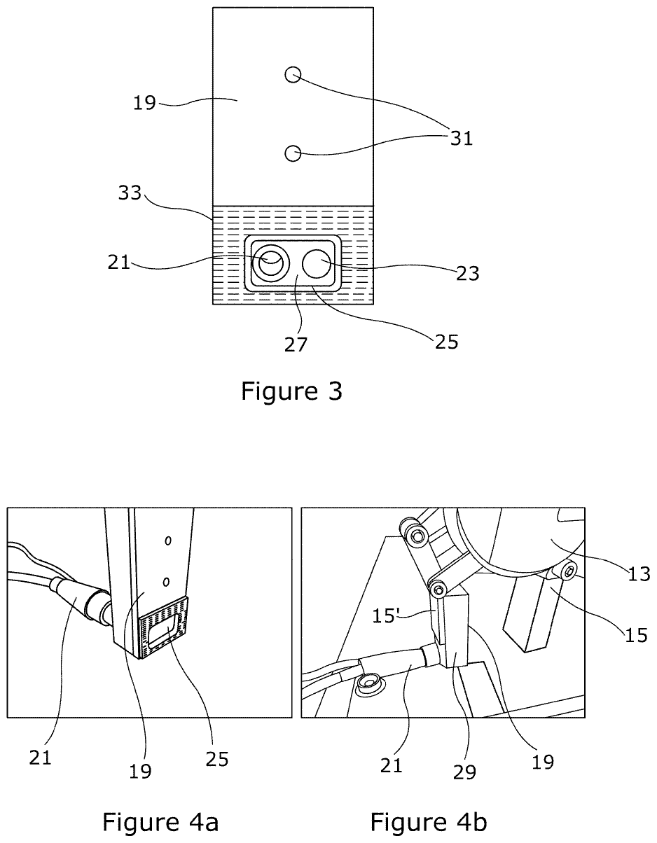

FIG. 3 illustrates a front-on view gripping surface of at least on gripping member of an article identification and/or sorting apparatus, in accordance with an embodiment of the present invention; and

FIGS. 4a-b illustrate a gripping member and gripping portion of an article identification and/or sorting apparatus, in accordance with an embodiment of the present invention;

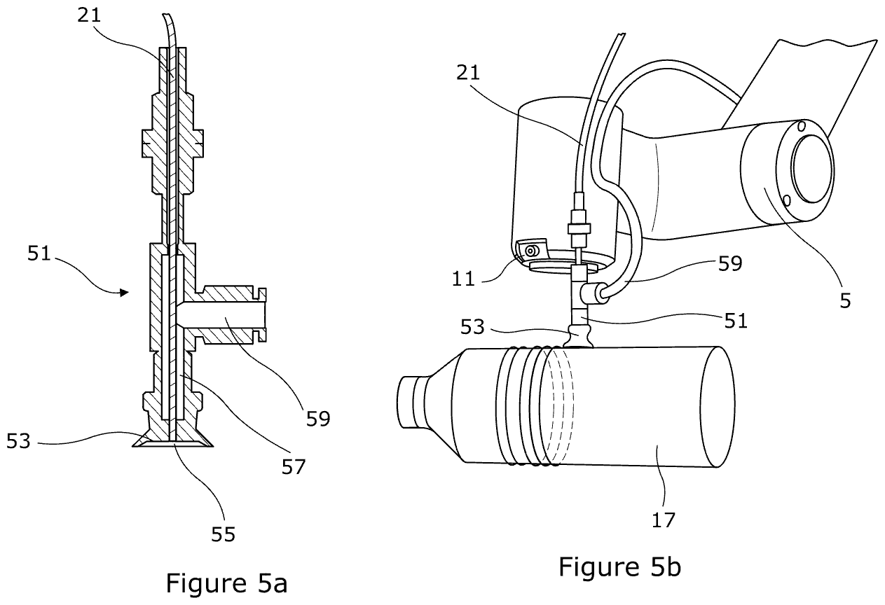

FIGS. 5a-b illustrate a cross-section of gripping member and a perspective view of a gripping portion and gripping member, of an article identification and/or sorting apparatus, respectively, gripping an article, in accordance with an embodiment of the present invention; and

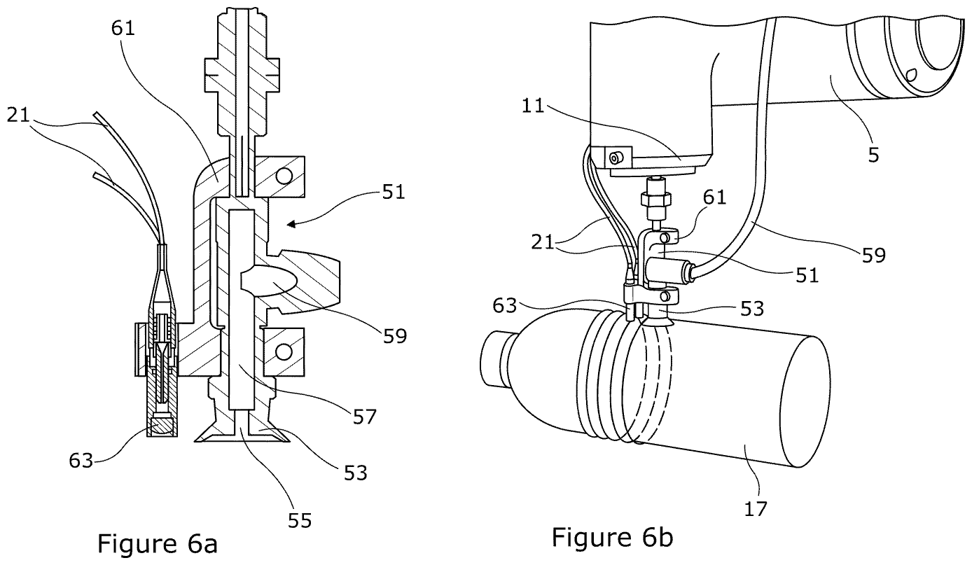

FIGS. 6a-b illustrate a cross-section of gripping member and a perspective view of a gripping portion and gripping member, of an article identification and/or sorting apparatus, respectively, gripping an article, in accordance with another embodiment of the present invention.

Referring now to the Figures, there is provided an article identification and/or sorting system 1. The system 1 includes, at its centre, an apparatus 3 comprising at least one automated or robotic arm 5. The arm 5 has a first, proximal end 7 which is generally anchored in position, either on a floor or support surface, or in connection with a framework 9 of the system 1. The arm 5 extends towards a second, distal end 11 wherein there is located a gripping portion in the form of a gripper 13 of the arm 5. The gripper 13 comprises two or more gripping members in the form of fingers 15 which are arranged to close and open to grab and release an article or garment 17, in use. Provided associated with one of the gripping fingers 15′ and a gripping surface 19 thereof are spectrometric identification means 21. In preferred embodiments, the spectrometric identification means are provided in the form of IR or NIR spectrometers, and a sensor 21 of which is integrated into the gripping finger 15′. This is best shown in FIGS. 3 and 4a-b, wherein the sensing portion 21 of the spectrometer extends from a rear (non-gripping) side of the finger 15′, and through an aperture such that it is directed outwardly and away from the gripping surface 19. The sensing portion 21 of the spectrometer may be provided as a fibre optic connector. At least one light source 23 is provided with the finger 15′ in order to illuminate the portion of the article or garment 17 which is gripped, allowing the sensing portion 21 to view the same and transmit the data to the spectrometer. The light source 23 is located adjacent the sensor 21 and s generally an IR light source such as an incandescent lamp, a halogen lamp, an LED, a superluminescent diode or a blackbody source.

The sensor 21 and light source 23 are located within a cavity or recess 25 formed in the gripping surface 19 of the 15′, and which is covered by a transparent glass or sapphire cover 27 to protect the sensor 21 and light 23 and provide a substantially continuous surface 19. In some embodiments, the gripping surface 19 may be formed integrally with the finger 15′. However, in other embodiments, the surface 19 may be provided as part of a detachable plate member 29, shown most clearly in FIG. 4b, and which is subsequently attachable to the gripping finger 15′ via connection holes and bolts 31. The gripping surface 19 of each of the fingers 15 may further be provided with, at least towards a distal end thereof, a textured or roughened surface 33 which serves to improve the gripping capabilities of the finger 15 when gripping an article or garment 17, in use.

The system 1 of the present invention further includes a number of containers located therewith. At least one “source” container 35 is provided, wherein a plurality of articles or garments 17 are located and which require identifying and sorting appropriately. At least two (although in the figures there are illustrated five) destination containers 37 are provided, wherein once the material composition of an article or garment 17 has been identified, it can be deposited into the appropriate container 37 by the arm 5 accordingly. These are illustrated in FIGS. 1 and 2. The apparatus 3 and system 1 further include computing means (not shown) which are connected with the spectrometer and the arm 5. The computing means are provided to resolve and analyse spectra obtained and subsequently determine the material composition of the article or garment 17 that has been gripped and analysed. This may further incorporate the use of machine learning algorithms and so in use after an article or garment 17 has been gripped by the gripping portion 13 of the arm 5 and the IR or NIR spectra resolved, the computing means will resolve the material composition and provide an output. Depending on the identified composition of the article or garment 17, a command is then sent to the arm 5 to move the garment 17 around to the appropriate destination container 37 and deposit the same therein. Further cameras 39 may also be provided associated with each of the source and destination containers 35, 37, located on the framework 9 so as to be directed towards and view into the containers and provided with stereo vision capabilities, enabling them to determine depth and, thus, how full/empty each of the containers are. The cameras 39 are provided in communication with the computing means, thus enabling the arm 5 to be paused in use if and when the source container 35 becomes empty and/or one of the destination containers 37 become full or exceeds a predetermined level.

The gripping portion 13 or the finger 15′ of the arm 5 may further include in some embodiments, optical identification means in the form of an RGB camera (not shown), which can be used, if required, to identify and subsequently sort articles or garments 17 by their predominant colour. This can be used instead of or in conjunction with the spectrometric identification means. For example, as discussed above, garment may only need to be identified and sorted according to their material composition. Alternatively, the garments 17 may only need to be sorted by colour, and so the RGB is required. In other examples, garments may need to be sorted according to both material composition and colour, thus, both the spectrometer and RGB camera may be required. The arm 5 or gripping portion 13 may also include one or more further features to improve and/or assist in its usage, such as:
further sensing means to determine the optimal pick-up point of the article or garment 17 from the source container 35. This is achieved by using machine vision and artificial intelligence (AI) which aids in maximising the chance of picking up the article or garment 17, finding the cleanest spot for IR/NIR analysis such as by avoiding labels etc., and ensuring only one article or garment 17 is picked up at a time;
stereoscopic and/or hyperspectral camera means provided to further aid in the identification of an article or garment 17;
metal detection means provided to detect metal disruptors located within the fabric of the article or garment 17 to be sorted;
RFID/NFC tag reading means provided to detect articles or garments 17 comprising such tags, and read the same; and/or
weight measuring means provided in the form of a load cell to determine the weight of an article or garment 17 to be sorted.

The system 1 and apparatus 3 may also incorporate wireless communication means enabling to be activated and controlled remotely by a user via software on a computer or via a downloadable mobile application. Data obtained by the system may also be transferred to a remote located, if required, via said wireless communication means.

The system 1 and apparatus 3 of the present invention therefore provides an efficient means by which numerous articles and garments 17 may be identified and sorted. The system 1, in a single action, is arranged to detect and grip an article or garment 17 to be identified, from the source container 35, determine the material composition of the same and while doing so, move to deposit it in the appropriate destination container 37. For example, a first destination container 37 may require articles composed of 100% cotton; and a second destination container 37 requires all other materials. Further destination containers 37, such as those shown in FIGS. 1 and 2, may be included to the system 1 thereby permitting a more precise separation of the articles by material composition, for example, 100% cotton, 100% polyester, polycotton blends, wool products, all other materials etc. This can be done with minimal human interaction—personnel may only be required to empty/replace destination containers 37 and refill/replace the source container(s) 35. However, it is not unrealistic to envisage even this process to be automated. The provision of stereo vision cameras 39 viewing into each container 35, 37, which are in direct communication with the computing means, means that the system 1 can detect when a container is empty or exceeds a predetermined load and can pause the same until that container has been emptied/refilled/replaced before restarting. The features of the system 1 significantly reduce labour costs, and it requires far less space than automated examples in the prior art. Thus, in the same such space, multiple systems of the present invention may be provided. The system 1 of the present invention is therefore more cost, time and space efficient compared to the prior art examples.

Referring now to FIGS. 5a-b and 6a-b, there is shown the distal end 11 of an alternative robotic arm 5 of an apparatus 3 forming part of an article identification and/or sorting system 1 as described above. FIGS. 5b and 6b illustrate an alternative gripping portion wherein there is provided a gripping member in the form of a vacuum gripper 51, which is shown in further detail in the cross-section drawings of FIGS. 5a and 6a. At a distal end of the gripper 51, there is provided a vacuum gripping surface in the form of a suction cup/head 53, which will directly contact an article to be analysed, in use. At least one aperture 55 is formed in the surface of the suction head 53, allowing a vacuum to be applied therethrough, which in turn enables the head 53 to apply the vacuum and suction to the article for gripping, in use. The interior of the gripper 51, which is substantially elongate, includes a channel 57 therein and extending along the length of the gripper 51. Vacuum supply means in the form of a vacuum supply line 59 connects with the gripper 51 and extends to the channel 57, permitting the vacuum to be applied therethrough. The spectrometric identification means include sensors in the form of one or more fibre-optic wires, or a fibre-optic wire bundle 21. The wires 21 connect, at first, proximal ends, to the spectrometric identification means and at least one light source. The distal ends of the wires 21 are arranged to be associated with the gripper 51 for sensing the material of the article being analysed, which is ultimately resolved by the spectrometric identification means. As previously mentioned, the light source is provided as an IR light source and preferably as any one of the following: incandescent lamp; halogen lamp; LED; superluminescent diode; or a blackbody source. The spectrometric identification means are provided in the form of an infrared (IR) spectrometer, preferably a near-infrared (NIR) spectrometer.

In one embodiment, depicted in FIGS. 5a-b, the spectrometric identification means or at least the sensors 21 thereof are provided to be located with the gripper 51. That is to say, the wires 21 extend through the channel 57 of the gripper 51 from a proximal end thereof, extending therethrough, terminating at the aperture 55 of the suction cup/head 53. In this arrangement, the sensing wires 21 are kept internally of the gripper 51 and there is a single point of contact between the gripping portion of the apparatus (the suction head 53) and the article 17 being analysed. In another embodiment of the invention, the sensing wires 21 are provided to be located adjacent and attached to the gripper 51. This is illustrated in FIGS. 6a-b, wherein a bracket or other such attachment device 61 is provided to ensure the wires 21 are maintained securely and substantially parallel to the gripper 51, the ends 63 of which are in-line with the suction head 53 when suction is being applied to the article 17 being analysed. This ensures that the heads/ends 63 of the wires 21 also firmly contact the article being analysed.

The embodiments of the present invention discussed in FIGS. 5 and 6 are a preferred version when the articles 17 to be analysed are formed of varying plastics materials. The firmer surfaces of such material allow for a vacuum grip to be applied which in most cases is far preferable to the use of finger grips 15, as illustrated in FIGS. 4a-b. The fingers 15 are, however, preferable in embodiments wherein the articles 17 to be analysed and sorted are formed primarily of fabrics materials, such as garments. In such examples vacuum grips would not be practical or possible, and so a finger- or vice-like grip would be preferable. The present invention therefore provides a novel and improved solution for the identification and/or sorting of various types of materials, with varying gripping portions which can be adapted according to the types of materials being analysed.

1. Inductive displacement sensor, said sensor comprising:
a magnetically permeable measuring head (100) arranged displaceably and/or rotatably on an elongated support (103),
at least one measuring loop (130) arranged on the support (103) whose geometric shape changes in response to a longitudinal/rotational displacement of the measuring head (100) along the support (103), and
at least one exciter loop (330, 335) arranged on the support (103), by means of which exciter loop (330, 335) a magnetic flux can be generated in the measuring head (100),
at least two measuring loops (310, 320) are provided, at least one first measuring loop (310) is designed geometrically in such a way that a response, changing essentially linearly along the inductive displacement sensor, to a magnetic excitation of the measuring head (100, 305) emerges with a longitudinal/rotation displacement of the measuring head (100, 305) along the support (300), and at least one second measuring loop (320) is formed geometrically in such a way that a periodically changing response to a magnetic excitation of the measuring head (100, 305) emerges with a longitudinal/rotational displacement of the measuring head (100, 305) along the support (300),
wherein at least two measuring loop pairs (310, 315, 320, 325) are provided, a at least one first measuring loop pair (310, 315) has at least two triangular measuring loops (310, 315) arranged symmetrically to one another and a at least one second measuring loop pair (320, 325) has at least two measuring loops (320, 325) formed to be sinusoidal or co-sinusoidal, and
wherein a geometric shape and a position of the measuring loops of the first measuring loop pairs (310, 315) and of the second measuring loop pairs (320, 325) are chosen in such a way that a sum of output values of the measuring loops of the first measuring loop pair (310, 315) is as constant as possible and that a sum of squares of output values of the measuring loops of the second measuring loop pair (320, 325) is as constant as possible.

2. The displacement sensor according to claim 1, wherein the at least one first measuring loop (310) is formed triangularly along the support (300) and the at least one second measuring loop is formed to be sinusoidal and/or co-sinusoidal along the support (300).

3. (canceled)

4. The displacement sensor according to claim 2, wherein at least two triangular measuring loops (310, 315) are arranged in mirror image to each other.

5. The displacement sensor according to claim 2, wherein the at least one first measuring loop (320) and the at least one second measuring loop (325) of the second measuring loop pair (320, 325) are arranged phase shifted in relation to each other by a predetermined phase value.

6. The displacement sensor according to claim 5, wherein segments of a sinusoidal or co-sinusoidal period of the at least one second measuring loop pair (320, 325) are periodically repeated, wherein the period length is arbitrary and can be in any range, preferably 100 mm.

7. (canceled)

8. (canceled)

9. The displacement sensor according to claim 1, having an automatic gain control, based on a feedback loop.

10. The displacement sensor according to claim 1, wherein the at least two exciter loops (330, 335) are formed in such a way that the magnetic flux penetrates at every point of a respective magnetic loop (310, 315, 320, 325, FIG. 2c).

11. The displacement sensor according to claim 1, wherein a coarse displacement of the measuring head (100, 305) along the support (300) is determined by means of the first measuring loop pair (310, 315, and a fine displacement of the measuring head (100, 305) along the support (300) is determined by means of the second measuring loop pair (320, 325).

12. The displacement sensor according to claim 11, wherein an actual displacement of the measuring head (100, 305) is determined from results of the coarse displacement and the fine displacement.

13. A control/evaluation unit for operating an inductive displacement sensor, said unit comprising:
a magnetically permeable measuring head (100) arranged displaceably and/or rotatably on an elongated support (103),
at least one measuring loop (130) arranged on the support (103) whose geometric shape changes in response to a longitudinal/rotational displacement of the measuring head (100) along the support (103),
at least one exciter loop (330, 335) arranged on the support (103), by means of which exciter loop (330, 335) a magnetic flux can be generated in the measuring head (100),
at least two measuring loops (310, 320) are provided, wherein at least one first measuring loop (310) is designed geometrically in such a way that a response, changing essentially linearly along the inductive displacement sensor, to a magnetic excitation of the measuring head (100, 305) emerges with a longitudinal/rotation displacement of the measuring head (100, 305) along the support (300), and wherein at least one second measuring loop (320) is formed geometrically in such a way that a periodically changing response to a magnetic excitation of the measuring head (100, 305) emerges with a longitudinal/rotational displacement of the measuring head (100, 305) along the support (300),
controller (225) for generating an exciter voltage (210) for exciting the at least two exciter loops (330, 335) by means of a digital to analogue converter (220) and by at least two demodulators (270, 280) for decoding the signals (260, 265) measured by means of the at least two measuring loops (310, 320), wherein the at least two demodulators (270, 280) are formed as synchronous demodulators working synchronously to each other, by means of which the at least two measuring signals (260, 265) are decoded, and wherein the controller (225) is formed as a programmable voltage source.

14. The control/evaluation unit according to claim 13, including a first feedback loop for the a signal amplitude.

15. The control/evaluation unit according to claim 13, wherein, based on a measured signal amplitude and based on a set excitation level, a signal quality is calculated which is linearly correlated with a physical alignment of the measuring head (100, 205) of the displacement sensor.

16. The control/evaluation unit according to claim 13, having a second feedback loop for the a signal frequency.

17. The control/evaluation unit according to claim 13, including a discontinuous signal measurement process, wherein the controller (225) sends “burst” excitation signals (555) to the at least two exciter loops (330, 335), with a voltage level set in advance and an oscillator frequency measured in advance.

18. The control/evaluation unit according to claim 15, wherein output signals of the demodulators (270, 280) are respectively supplied to a demodulator/capacitor (275, 285), the output voltages of which are proportional to a current position of the measuring head (100, 205), wherein an output voltage of the first demodulator/capacitor (275) corresponds to a coarse displacement of the measuring head (100, 205) and an output voltage of the second demodulator/capacitor (285) corresponds to a fine displacement of the measuring head (100, 205).

19. The control/evaluation unit according to claim 13, wherein by means of the at least two demodulators/capacitors (275, 285) the decoded signals, i.e. the outputs of the demodulators (270, 280), are multiplexed and supplied to an analogue to digital converter (290) in order to obtain a consistent channel chain for the at least two measuring signals (260, 265).
